(19) United States
(12) Patent Application Publication
(10) Pub. No.: US 2013/0269141 A1
(43) Pub. Date: Oct. 17, 2013

(54) WINDSHIELD WIPER FRAME

(71) Applicant: YUAN-CHIN KU, NEW TAIPEI CITY (TW)

(72) Inventor: YUAN-CHIN KU, NEW TAIPEI CITY (TW)

(73) Assignee: DONGGUAN HONGYI WIPER CO., LTD., DONG GUAN CITY (CN)

(21) Appl. No.: 13/447,404

(22) Filed: Apr. 16, 2012

(51) Int. Cl. B60S 1/40

(52) U.S. Cl. 15/250.32

(57) ABSTRACT

The instant disclosure relates to a high strength wiper frame, which includes a pair of wiper arms, a frame portion, and at least one support shaft. The wiper arms are used for mounting a wiper blade assembly. The opposite ends of the frame portion are connected to the wiper arms. The frame portion has a pair of thin walls defining a receiving space thereinbetween. The hardness of the support shaft is greater than the hardness of the thin walls, and the support shaft is disposed in the receiving space. The opposite ends of the support shaft are insert molded into the thin walls. The wiper frame is lightweight, structurally rigid, and can protect the wiper connector disposed in the receiving space. The manufacturing of the wiper frame does not require complicated mold or technology. Rather, the wiper frame can be fabricated with simple manufacturing steps and is cost-effective.

### BACKGROUND OF THE INVENTION

1. Field of the Invention

The instant disclosure relates to a high strength wiper frame; more particularly, to a high strength and light weight wiper frame for mounting a wiper blade assembly and a wiper connector.

2. Description of Related Art

Please refer to FIG. 1, which shows a conventional wiper frame Z′ for receiving a wiper connector Y The wiper connector Y is for connecting to a driving arm. A wiper blade assembly is disposed underneath the wiper frame. When the driving arm is in motion, the wiper blade assembly and the wiper frame Z′ are set in motion by the wiper connector Y to sweep rain, dust, or snow off the windshield.

Generally, the wiper connector Y is disposed in a frame portion 1′ (i.e., central portion) of the wiper frame Z′. The frame portion 1′ has two opposite thin walls 11′ and a support shaft 2′ disposed thereinbetween for structural reinforcement. Conventionally, the wiper frame Z′ is constructed with: a metallic material that has high hardness to avoid any structural weak spot for the frame portion 1′; a plastic material for integrally forming the support shaft 2′ on the frame portion 1′; or a plastic material for the frame portion 1′ with the support shaft 2′ being a rivet. However, the whole metallic wiper frame Z′ is too heavy, which reduces the wiping force. Whereas the wiper frame Z′ made of plastic material is more lightweight. Yet, to maintain the structural rigidity of the frame portion 1′, the walls 11′ and the support shaft 2′ must be sized larger. Thus, the wiper frame Z′ would take up more space, which creats assembling issues with the wiper connector Y. Although the use of the rivet as the support shaft 2′ can improve the mechanical strength of the wiper frame Z′ and avoid the sizing issue, but the additional riveting process will increase the manufacturing time and cost.

Therefore, the existing manufacturing methods are unable to fabricate a lightweight, downsized, and cost-effective wiper frame.

### SUMMARY OF THE INVENTION

The object of the instant disclosure is to provide a high strength wiper frame for mounting a wiper blade assembly and disposing a wiper connector. The wiper frame of the instant disclosure is light weight, downsized, and structurally rigid.

The high strength wiper frame of the instant disclosure comprises two wiper arms, a frame portion, and at least one support shaft. The wiper arms are used for mounting the wiper blade assembly. The opposite ends of the frame portion are connected to the wiper arms. The frame portion has two oppositely arranged thin walls in forming a receiving space. The support shaft has a hardness greater than the hardness of the thin walls and is disposed in the receiving space. The opposite ends of the support shaft are insert molded into the thin walls.

The wiper frame of the instant disclosure has the following advantages. The frame portion of the wiper frame is constructed with plastic material to obtain a high strength and lightweight wiper frame. The use of the support shaft having greater hardness than the surrounding thin walls provides greater structural rigidity for interconnecting the wiper frame to the wiper connector. In comparing to conventional wiper frame, where the frame portion is entirely made of metallic material, the frame portion is made of plastic material connected to a rivet, or both the frame portion and the support shaft are made of plastic material but having enlarged size, the wiper frame of the instant disclosure is lightweight and structurally rigid to provide adequate protection of the wiper connector inside the receiving space.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an exploded view of a conventional wiper assembly showing a wiper connector and a portion of a wiper frame.

FIG. 2 is an isometric view of a high strength wiper frame of the instant disclosure.

FIG. 3 is a top view of the high strength wiper frame of the instant disclosure.

FIG. 4A is a front view of a support shaft of the instant disclosure.

FIG. 4B is a cross-sectional view of the support shaft of the instant disclosure.

FIG. 5 is a front view of an I-shaped support shaft of the instant disclosure.

FIG. 6 is a front view of a Z-shaped support shaft of the instant disclosure.

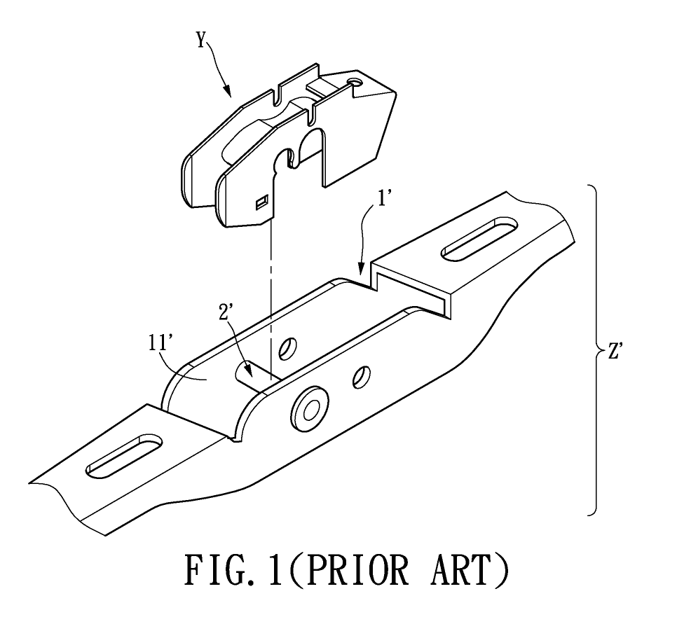

### DETAILED DESCRIPTION OF PREFERRED EMBODIMENTS

The instant disclosure provides a high strength wiper frame for disposing a wiper connector therein and mounting a wiper blade assembly.

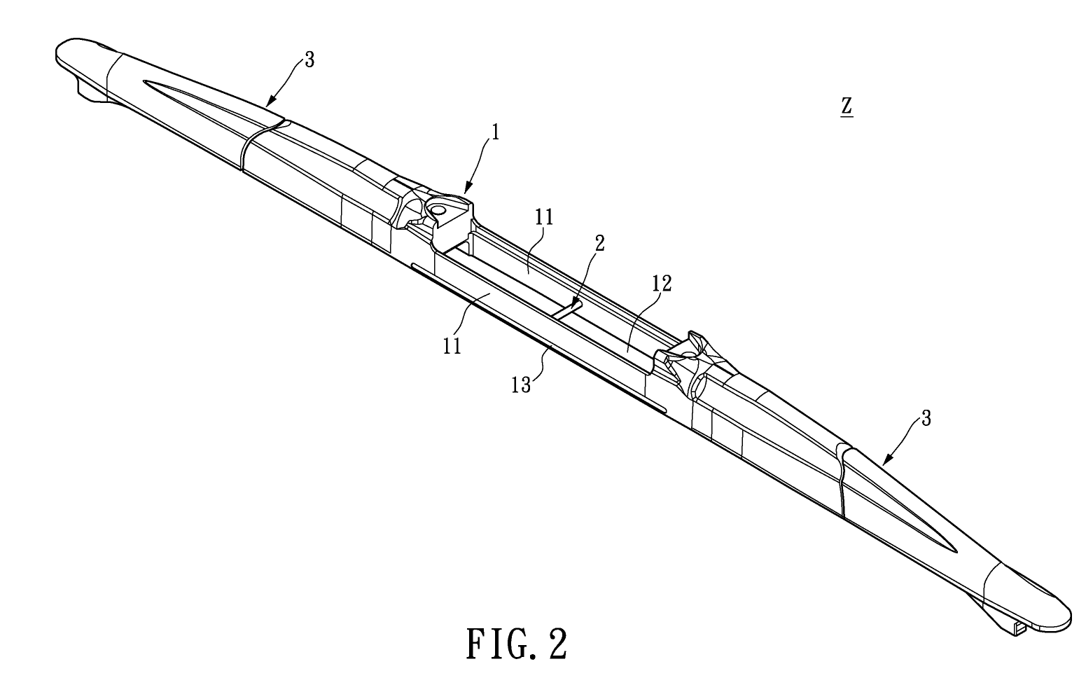

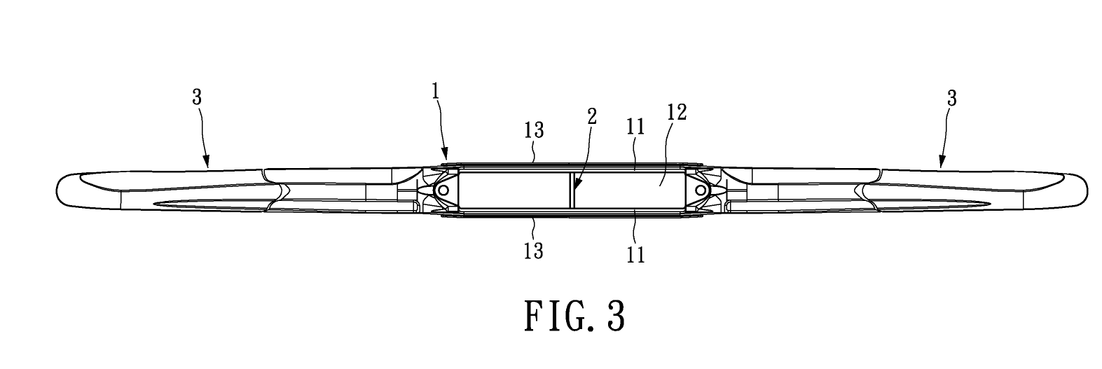

Please refer to FIGS. 2 and 3, which show the high strength wiper frame Z of the instant disclosure. The wiper frame Z comprises two wiper arms 3, a frame portion 1, and a support shaft 2. The wiper arms 3 are used for mounting a wiper blade assembly (not shown). The opposite ends of the frame portion 1 are connected to the wiper arms 3. The frame portion 1 has a pair of opposite thin walls 11 facing each other. Each of the thin walls 11 has a reinforcement rib 13. A receiving space 12 is defined by the thin walls 11 on the frame portion 1. The support shaft 2 is disposed in the receiving space 12 in forming the high strength wiper frame Z. The number of support shafts is not restricted by the examplary embodiment.

For weight reduction purpose, the wiper arms 3 of the high strength wiper frame Z is preferably made of plastic material, and the frame portion 1 is preferably a plastic rectangular structure.

The support shaft 2 is arranged between the thin walls 11 and in the receiving space 12. More specifically, the opposite ends of the support shaft 2 are insert molded into the opposing thin walls 11. Thus, the receiving space 12 defined by the thin walls 11 and reinforced structurally by the support shaft 2 is more rigid.

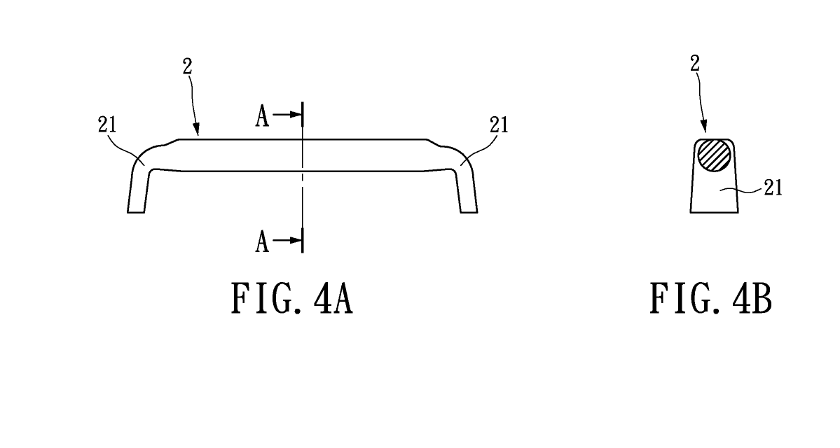

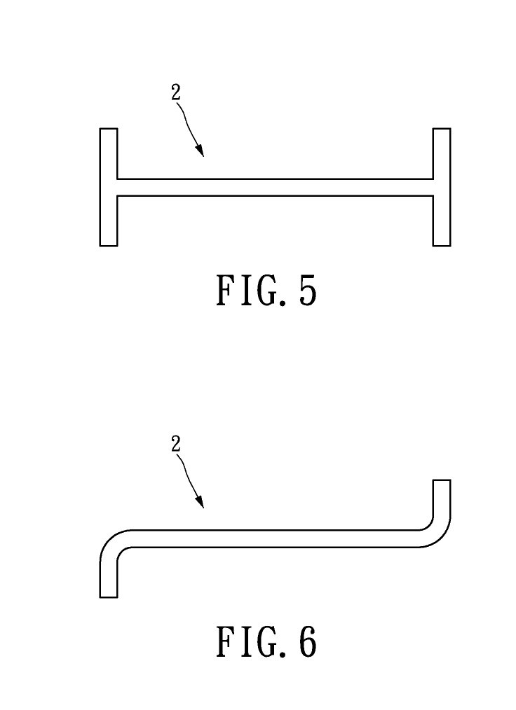

Regarding the shape of the support shaft 2, please refer to FIGS. 4A and 4B. FIG. 4B is a cross-sectional view of the support shaft 2 shown in FIG. 4A taken along a cut line A-A. A bending portion 21 is formed at each of the opposite ends of the support shaft 2. Each of the bending portions 21 is flattened and recessed into the adjacent thin wall 11. As shown in FIG. 2, the bending portions 21 are embedded in the thin walls 11. The support shaft 2 bridges the thin walls 11 in a substantially perpendicular fashion. Because the thickness of the thin walls 11 is restricted, each of the opposite ends of the shaft support 2 is preferably formed into the bending portion 21. The bending portions 21 are embedded in the thin walls 11, thus enabling the support shaft 2 to connect bendingly with the thin walls 11. The flattened bending portions 21 enhance the contacting surface area between the support shaft 2 and the thin walls 11. Thus, the support shaft 2 is disposed securely on the frame portion 1. However, neither the number of bending portions 21 nor the bending direction is restricted. As shown in FIGS. 5 and 6, the support shaft 2 may be I-shaped or Z-shaped, respectively.

For the instant embodiment, the support shaft 2 has a hardness that is higher than the thin walls 11 hardness. The support shaft 2 is constructed with a material that is different from the material used for making the frame portion 1 and the wiper arms 3 and has a higher hardness. The support shaft 2 is preferably made of steel, iron, or other high hardness material. Although the conventional plastic support shaft can be formed integrally with the thin walls, the plastic support shaft must be sized up to provide sufficient strength in supporting the thin walls. For the instant embodiment, the conventional plastic support shaft is replaced by the support shaft 2 that have higher hardness. Thus, the support shaft 2 can be slimmed to take up less space.

For the instant embodiment, the support shaft 2 is insert molded to the thin walls 11. Thus, the high strength wiper frame Z is integrally formed from the high hardness support shaft 2 and the plastic thin walls 11 that have a different hardness. Because the traditional metal support shaft is riveted to the thin walls, holes must be pre-formed on the thin walls. Not only does the appearance of the wiper frame is negatively affected, but the extra riveting operation also increases the manufacturing time and cost. For the instant embodiment, the insert molding technique is employed to combine the metal support shaft 2 with the plastic thin walls 11 of the frame portion 1. When the frame portion 1 is removed from the mold, the support shaft 2 is already disposed on the thin walls 11 of the frame portion 1. The riveting process is not necessary, which can help to reduce the manufacturing cost and increase the production speed.

In conjunction with FIGS. 2 and 4, the manufacturing method of the wiper frame Z of the instant disclosure is described hereinbelow:

First, at least one support shaft 2 is provided. The support shaft 2 of the instant embodiment is a metallic tubular shaped member having two opposite ends each having one bending portion 21.

Next, the support shaft 2 is loaded into a mold (not shown) for insert molding.

Then, molten plastic is injected into the mold. The injected molten liquid cools and forms the thin walls 11 that surrounds the bending portions 21. Thus, the bending portions 21 of the support shaft 2 are entirely embedded in the thin walls 11.

Finally, after the molten plastic has hardened in forming the frame portion 1, the mold is removed. The hardened frame portion 1 has two thin walls 11 that define the receiving space 12. The opposite thin walls 11 are bridged by the metal support shaft 2, which provides structural support for the thin walls 11 and the receiving space 12.

To complete the manufacturing process, the frame portion 1 is connected to the wiper arms 3 in forming the high strength wiper frame Z. For the instant embodiment, the frame portion 1 and the wiper arms 3 are individually constructed before being assembled together. However, the frame portion 1 and the wiper arms 3 can be made of the same material. In other words, based on the practical needs and the actual requirement of the application, the frame portion 1 and the wiper arms 3 can be integrally formed as an one-piece unit in a mold. The one-piece construction of the wiper frame Z does not conflict with the operation of combining materials having different surface hardness (e.g., support shaft 2 of high hardness vs. frame portion 1 of low hardness).

The wiper frame Z of the instant disclosure has the following advantages. The frame portion 1 of the wiper frame Z is constructed with plastic material to obtain a high strength and lightweight wiper frame. The use of the metal support shaft 2 for supporting the thin walls 11 and the receiving space 12 provides greater structural rigidity for interconnecting the wiper frame Z to the wiper connector. In comparing to conventional wiper frame, where the frame portion is entirely made of metallic material, the frame portion is made of plastic material connected to a rivet, or both the frame portion and the support shaft are made of plastic material but having enlarged size, the wiper frame Z of the instant disclosure is lightweight and structurally rigid to provide adequate protection of the wiper connector inside the receiving space 12. Moreover, the instant disclosure doesn't require complicated molds or technology. The corresponding manufacturing process is simple to carry out and is very cost-effective.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims

What is claimed is:

1. A high strength wiper frame, for connecting a wiper blade assembly and a wiper connector, comprising:
a pair of wiper arms for mounting the wiper blade assembly;
a frame portion having opposite ends connected to respective wiper arms, wherein the frame portion further has a pair of thin walls to form a receiving space therein between; and
at least one support shaft having a hardness higher than the hardness of the thin walls disposed in the receiving space, wherein the opposite ends of the support shaft are insert molded in the thin walls
wherein each of the opposite ends of the support shaft forms a bending portion, the bending portion being bent toward a same substantial direction;
wherein the bending portions are embedded in thin walls;
wherein the support shaft is constructed with metallic material.

2. (canceled)

3. (canceled)

4. The high strength wiper frame of claim 1, wherein each of the thin walls has a reinforcement rib.

5. The high strength wiper frame of claim 1, wherein the support shaft is constructed of steel, iron, or a type of metallic material having high hardness.
